(19) United States
(12) Patent Application Publication
(10) Pub. No.: US 2013/0290210 A1
(43) Pub. Date: Oct. 31, 2013

(54) SYSTEM AND METHOD FOR AUTOMATING PRE-EMPLOYMENT ASSESSMENT

(71) Applicant: FURSTPERSON, INC., Rockford, IL (US)

(72) Inventors: Michelle Cline, Rockford, IL (US); Brent Holland, Rockford, IL (US); Dawn Lambert, Rockford, IL (US); Jeff Furst, Rockford, IL (US)

(73) Assignee: FurstPerson, Inc., Rockford, IL (US)

(21) Appl. No.: 13/871,294

(22) Filed: Apr. 26, 2013

Related U.S. Application Data
(60) Provisional application No. 61/639,475, filed on Apr. 27, 2012.

(51) Int. Cl. G06Q 10/10

(52) U.S. Cl. CPC G06Q 10/1053
USPC 705/321

(57) ABSTRACT

A system and method for automating pre-employment assessment includes a job analysis engine to receive end-user preferences of a target job, an automated job mapping, validation engine in communication with the job analysis engine, where the automated job mapping, validation engine is to receive end-user performance metrics for the target job, and workflow logic and automation in communication with the automated job mapping, validation engine, where the workflow logic and automation are to provide an end-user employee-selection model, such that the end-user employee-selection model recommends assessment battery options for the new job based on job analysis of the target job, mapping of the target job to archived jobs, and the performance metrics for the target job.

### CROSS-REFERENCE TO RELATED APPLICATIONS

This application claims priority under 35 U.S.C. §119(e) to U.S. Provisional Patent Application Ser. No. 61/639,475 filed on Apr. 27, 2012, and incorporated herein by reference.

### BACKGROUND

Employees are critical providers of service to a company's customers and one of the backbones of a company's business. Thus, finding, hiring, and retaining employees who will perform at a consistently high level and provide quality service and support is vital to a company's success. In this regard, solutions aimed at enhancing the selection process will provide a company with a competitive advantage.

### BRIEF DESCRIPTION OF THE DRAWINGS

FIG. 1 is a flowchart illustrating one example of process steps of a system and method for automating pre-employment assessment according to the present disclosure.

FIG. 2 is a block diagram illustrating one example of a system for automating pre-employment assessment according to the present disclosure.

FIGS. 3-8 are screenshots illustrating one implementation of a system and method for automating pre-employment assessment according to the present disclosure.

FIG. 9 illustrates one example of a self-service implementation process for automating pre-employment assessment according to the present disclosure.

FIGS. 10-33 illustrate one example of a validation on demand system and method as an example of a system and method for automating pre-employment assessment according to the present disclosure.

### DETAILED DESCRIPTION

In the following detailed description, reference is made to the accompanying drawings which form a part hereof, and in which is shown by way of illustration specific embodiments in which the present disclosure may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

### Approach and Rationale

Individuals differ in terms of a wide variety of characteristics that relate to important work outcomes. To the extent that an organization can measure individual differences and pinpoint those characteristics with the strongest potential to predict important work outcomes, that organization will enjoy a competitive advantage in its ability to hire and retain individuals with the greatest likelihood of long-term, on-the-job success. In general, there are two keys to making the measurement of individual differences useful in predicting important work outcomes: (1) knowing what to measure, and (2) measuring it well.

### Knowing What To Measure

Employee behavior and performance, even in a limited context such as within a specific job, reflect many individual characteristics working in concert. Given the complex interactions among these personal qualities, it is generally good practice to try to measure as many of them as is practically feasible. If the measurement of individual differences is overly limited, an organization will overlook important characteristics needed to predict employee success, and reap lower returns from any investment in a pre-hire assessment process. As recommended by the U.S. Department of Labor (U.S. Department of Labor, Employment and Training Administration. (1999). Testing And Assessment: An Employer's Guide To Good Practices. Washington, D.C.: Author.), a “whole-person approach” to assessment, using a variety of measures rather than over-relying on any single assessment or procedure is employed. This approach helps to ensure that the characteristics measured are not only relevant to important employee behaviors, but also adequately cover the spectrum of individual differences that result in varying levels of on-the-job success.

Utilizing a variety of pre-hire tools is a good strategy (Dunnette, M. D. (1966). Personnel Selection and Placement. Oxford: Wadsworth.) for increasing the defensibility of the pre-hire selection system as a whole (Pulakos, E. D., & Schmitt, N. (1996). An Evaluation Of Two Strategies For Reducing Adverse Impact And Their Effects On Criterion-Related Validity. Human Performance, 9(3), 241-258.), and is supported by Schmidt and Hunter's (Schmidt, F. L., & Hunter, J. E. (1998). The Validity And Utility Of Selection Methods In Personnel Psychology: Practical And Theoretical Implications Of 85 Years Of Research Findings. Psychological Bulletin, 124, 262-274.) research on the validity of various selection methods and their focus on the incremental gains in validity that can be experienced by combining methods.

In this context, a 4-Quadrant model of job performance reflecting a culmination of experience and research has been developed. This model highlights the multi-dimensional nature of employee performance within contact centers by proposing that an employee's on-the-job success is a function of:

(a) what an individual can do, which includes
work habits (e.g., dependability, detail orientation, organizational skills),
cognitive capabilities (e.g., critical thinking, decision-making, problem-solving), and
interpersonal characteristics (e.g., sociability, interpersonal sensitivity, empathy); and

(b) what an individual will do, which depends on his or her work-related attitudes, interests, and motivations.

The developed 4-Quadrant model corresponds well with Hogan and Warrenfeltz's (Hogan, R., & Warrenfeltz, R. (2003). Educating The Modern Manager. Academy of Management Learning and Education, 2(1), 74-84.) domain model of performance. In this regard, excellent performance within, for example, a contact center environment, depends on possessing competence in each of the four domains; the model is not compensatory, so strength in one Quadrant is unlikely to compensate for weakness in another Quadrant. While the model is, first and foremost, a model of job performance, it can also be used to classify the predictors necessary to ensure high performance in each Quadrant. The implication is that effectively matching an applicant to a job requires a diverse array of predictors to ensure adequate coverage of all four Quadrants. There is no “magic” test that can measure all four quadrants simultaneously. Best practice organizations often use several assessments to ensure the applicant possesses the requisite level of competence in each quadrant. Thus, this model provides a map of what to measure, and provides added support for the “whole-person approach” to pre-hire assessment.

The relative importance of each of the Quadrants, however, varies across jobs and organizations. Also, knowing the importance of the variety of behaviors, or “competencies”, in these Quadrants to on-the-job success should be considered. For this reason, Uniform Guidelines On Employee Selection Procedures (Equal Employment Opportunity Commission (1978). Uniform Guidelines On Employee Selection Procedures. Federal Register, 43, 38,290-38,315.) and best practices recommend conducting (1) an initial job analysis in order to understand the work and the specific worker requirements, and (2) a validation study to identify which portions of the assessment(s) most strongly relate to important work outcomes.

### Measuring It Well

According to Principles for the Validation and Use of Personnel Selection Procedures (Society for Industrial and Organizational Psychology. (2003). Principles for the Validation and Use of Personnel Selection Procedures (4th ed.). Bowling Green, Ohio: Author.), “validity is the most important consideration in developing and evaluating selection procedures” (p. 4). This is because the validity of a pre-hire tool provides evidence for the job relevance of that tool, which helps not only to ensure the utility of the tool in the workplace, but also to ensure the legal defensibility of the instrument as part of the selection system, according to the Uniform Guidelines (Equal Employment Opportunity Commission (1978). Uniform Guidelines On Employee Selection Procedures. Federal Register, 43, 38,290-38,315.). Thus, in order to know that we have measured what we intended to measure, and that we have measured it “well”, we must gather validity evidence.

In an employment context, validity evidence is typically the most meaningful because the primary inference is that a score on the pre-hire assessment will predict a subsequent criterion (i.e., work behavior) (Society for Industrial and Organizational Psychology. (2003). Principles for the Validation and Use of Personnel Selection Procedures (4th ed.). Bowling Green, Ohio: Author.).

### Overview

In the context of the above, a system and method for automatically creating a customized pre-employment assessment tool for use, for example, in employee selection, has been developed. The system and method combines multiple processes into a single, overarching system that uniquely integrates job analysis, validation, cut-off scores, reporting, and implementation.

Within the system and method exist unique components or modules designed for a single, overarching system including, for example:
job analysis survey methodology in which competencies are identified and analyzed;
transportability and synthetic validation routines;
on-the-fly calibration of cut-off scores;
on-the-fly technical reports; and
automated routines that drive implementation based on end user preferences.

### Basic Information

In one example, the system and method is implemented via a web portal through which a client can submit key business requirement data and job analysis information, and receive virtually real-time recommendations on an assessment battery empirically demonstrated to predict desired performance outcomes at a high level. In one implementation, such recommendations are made using transportability and synthetic validation algorithms. In addition, the system and method uses worker-oriented job analysis surveys (and supporting job analysis data) that allow subject matter experts to rate the importance of a large array of competencies that research has shown to be important across different jobs (including, e.g., customer-contact jobs).

A first step of the system and method is to identify subject matter experts (SMEs) and invite them to complete the job analysis survey. Such subject matter experts are deemed, for example, to possess considerable knowledge of the target job. With the job analysis surveys distributed, the client is prompted to input key information to help narrow the list of potential assessments that are most appropriate for the needs of the business. For example, the client will estimate the pass rate on the assessment battery, establish the desired testing time for the assessment battery, and identify the investment the client is willing to make into pre-hire assessments. Each of these inputs helps narrow the suite of assessments that are appropriate for the client based on business demands.

A next step of the system and method is for the client to rank the importance of key performance outcomes (e.g., first-call-resolution and customer satisfaction, attrition, and sales). The relative ordering of these criteria, in conjunction with the job analysis data and other client-driven inputs, enable the system to select a customized battery of assessments to address the client's business objectives.

### Analytics

In one example, once a minimum number of SMEs complete the survey, a series of automated routines are engaged. In one implementation, the system evaluates correspondence among raters using outlier analysis and within-group inter-rater reliability statistics (rwg) to ensure adequate reliability before computing any summary-level statistics. If the reliability is below a minimum established threshold, the system prompts the client to invite additional SMEs to participate in the process. Once adequate reliability has been achieved, the system computes the criticality of each competency and rank orders them from most critical to least critical.

Then, using profile comparison statistics, the systems compares the new client's job profile to the profiles stored in a data warehouse to identify the best match from which to transport validity. In one example, transportability and synthetic validation are computed for every job. Applying both methods helps (1) to minimize gaps or holes in the recommendations because of limitations with the archived research studies (e.g., an empirical study deemed appropriate to transport may not include the full range of tests or assessments necessary to measure all the critical competencies in a target job) and (2) to deliver recommendations in the event that none of the archived jobs are similar enough to the target job to justify transportability validation. In the event that no job meets the minimum criteria to be declared a match, the system uses synthetic validity to make recommendations on an appropriate assessment battery.

Once recommendations have been made by the system, a next step is for the system to propose a passing threshold (i.e., cutoff scores) and evaluate different combinations for adverse impact using an archival applicant pool of job applicants (e.g., tens of thousands of customer-contact job applicants, not students or incumbents.) The proposed recommendations and potential adverse impact are then shared with the client so that they can choose the model that best meets their needs. A final step is for the system to prepare a complete technical report that summarizes the research process, results, recommendations, and adverse impact estimates. In one example, the report conforms to the technical standards outlined in the Uniform Guidelines On Employee Selection Procedures (Equal Employment Opportunity Commission (1978)).

### Process Steps:

Further outlined below are process steps implemented by one example of the pre-employment assessment system and method. While such steps are provided in a numbered order, it is understood that an order of implementation of the steps may vary, and that multiple steps may be performed simultaneously or at different times. In addition, less than all steps or multiple occurrences of a particular step may be performed during an example implementation of the system and method.

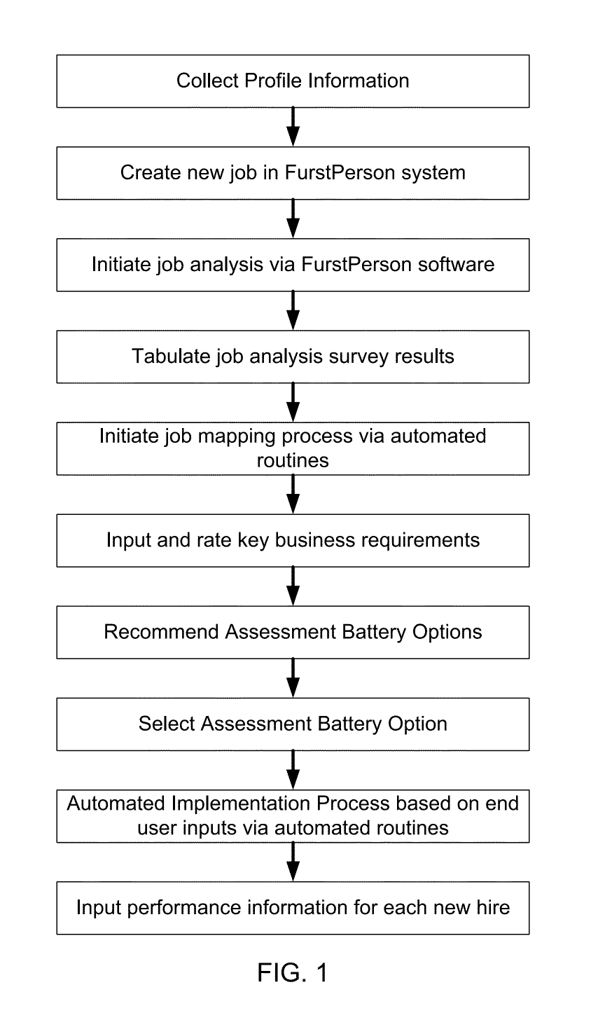

Illustrated in the flowchart of FIG. 1 is one example of process steps of a system and method for automating pre-employment assessment and creating a customized pre-employment assessment tool. Process steps implemented by the system and method include:

1. Creating Client Profile. In one example, creation of a client profile is implemented through a self-service portal.

2. Creating New Job. In one example, creation of a new job is implemented through a self-service portal, and includes:
a. entering basic job information; and
b. creating a job description by, for example:
   i. uploading own job description;
   ii. entering job description by job competency/functional area; or
   iii. editing sample job description provided by the system.

3. Initiating Job Analysis. In one example, initiation of the job analysis includes:
a. selecting Subject Matter Experts (SMEs) to complete a job analysis survey;
b. selecting a timeline to complete the survey; and
c. sending the survey.

4. Tabulating Survey Results. In one example, tabulation of the job analysis survey results is performed by an automated routine within the system.

5. Confirming Inter-Rater Reliability. In one example, confirmation of inter-rater reliability is performed by an automated routine within the system, and includes:
a. if inter-rater reliability is not acceptable, redirecting the user to gather more survey results (i.e., participants); and
b. if inter-rater reliability is acceptable, closing out survey.

6. Job Mapping. In one example, a job mapping process is performed by an automated routine within the system, and includes, for example:
a. identifying primary competencies for a target job;
b. computing transportability job analysis survey differences (D-Squared);
c. computing match score to identify job to transport from;
d. using transport evidence to identify potential predictors from matched job; and/or
e. using synthetic evidence to identify any additional potential predictors.

7. Rating Business Requirements. In one example, key business requirements for a job are input and rated by an automated routine within the system, and include, for example:
a. pass rate;
b. preferred testing length; and
c. performance metrics.

8. Recommending Assessment Battery Options. In one example, recommendation of assessment battery options is implemented by an automated routine within the system, and includes, for example:
a. recommending a combination of assessments for a job family based on automated analysis;
b. distinguishing from a broad portfolio of assessment content (i.e. tests) including, for example:
   i. biographical data;
   ii. personality;
   iii. cognitive; and
   iv. simulations; and
c. statistical comparison including, for example:
   i. Transportability and Synthetic validation algorithms.

9. Selecting Assessment Battery Option. In one example, the end user selects an assessment battery option from the recommended options.

10. Determining Assessment Scoring Model and AI Analysis. In one example, determination of an assessment scoring model and AI analysis is performed by an automated routine within the system.

11. Generating Technical Report. In one example, generation of a technical report is performed by the system. The technical report, for example:
a. summarizes process;
b. summarizes recommendations; and
c. summarizes adverse impact estimates.

12. Enabling System for Production Use. In one example, the end user enables the system for production use. Such enabling includes, for example:
a. establishing a project in the end user profile; and
b. requesting inputs and automatically creating workflow procedures including, for example:
   i. password procedure;
   ii. user set-up; and
   iii. reapply policy.

13. Using the System. In one example, the end user begins use of the system as a self-service employee selection system.

14. Enabling Closed-Loop Analytics. In one example, closed-loop analytics are implemented with the system, and include, for example:
a. enabling of the system by the end user to automatically capture performance data from hiring manager performance appraisals and surveys or from automated databases holding performance metrics; and
b. automatically analyzing performance data to establish linkages between job performance and hiring information.

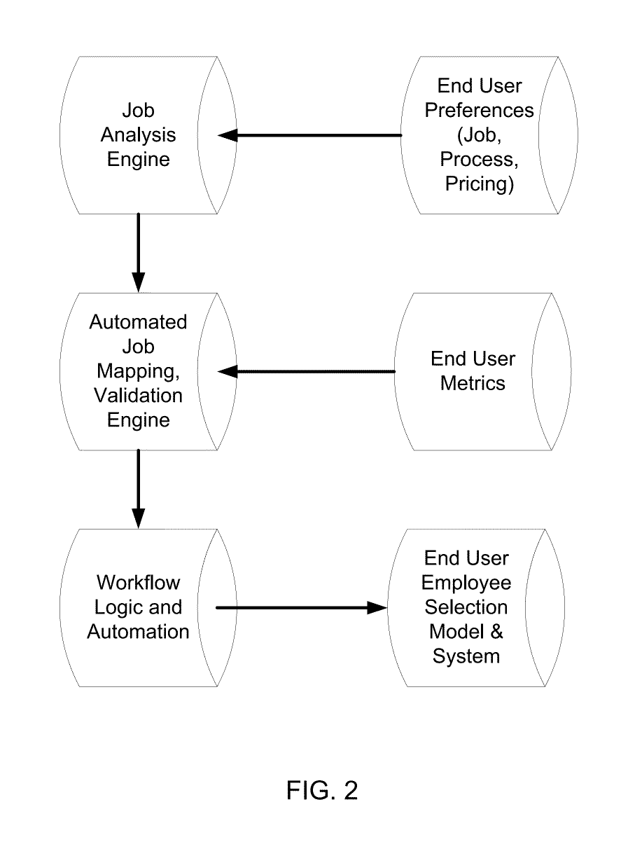

Illustrated in the block diagram of FIG. 2 is one example of a system for automating pre-employment assessment and creating a customized pre-employment assessment tool. In one example, the system is implemented by a computer or computing system including a memory and a processor, with associated hardware and/or machine readable instructions (including firmware and/or software), for implementing and/or executing computer-readable, computer-executable instructions for data processing functions and/or functionality. In one example, a program including instructions accessible and executable by the processor of the system is stored in a non-transitory storage medium that may be integral to the system or may be located remotely and accessible, for example, over a network. Storage media suitable for tangibly embodying program instructions and data include all forms of computer-readable memory including, for example, RAM, semiconductor memory devices, such as EPROM, EEPROM, and flash memory devices, magnetic disks such as internal hard disks and removable hard disks, magneto-optical disks, DVD-ROM/RAM, and CD-ROM/RAM, among others.

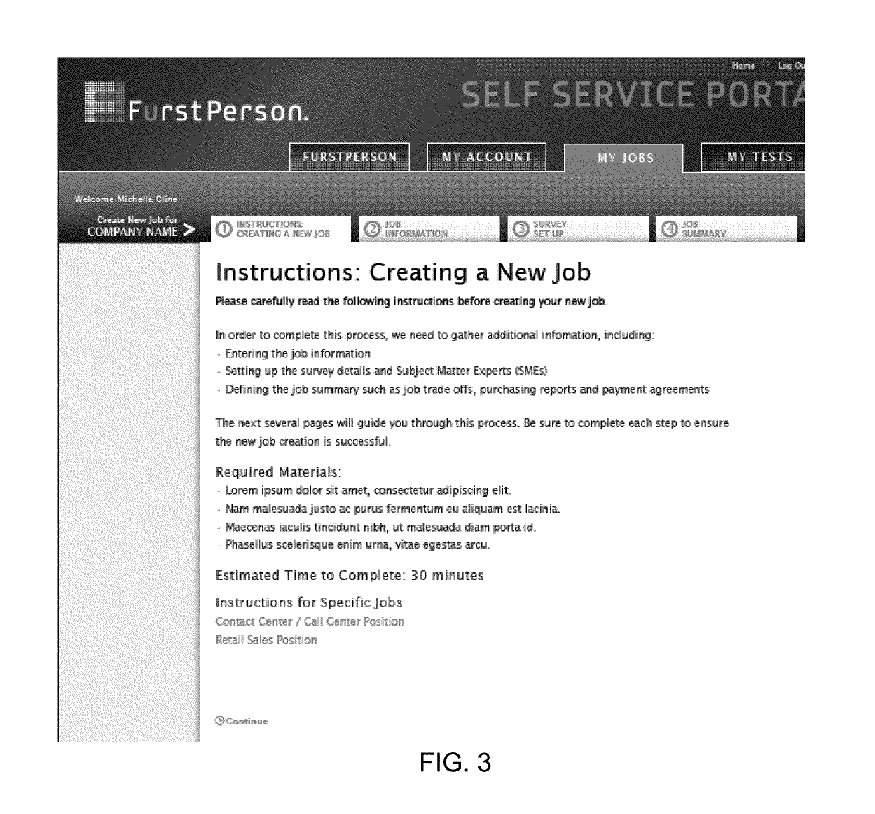

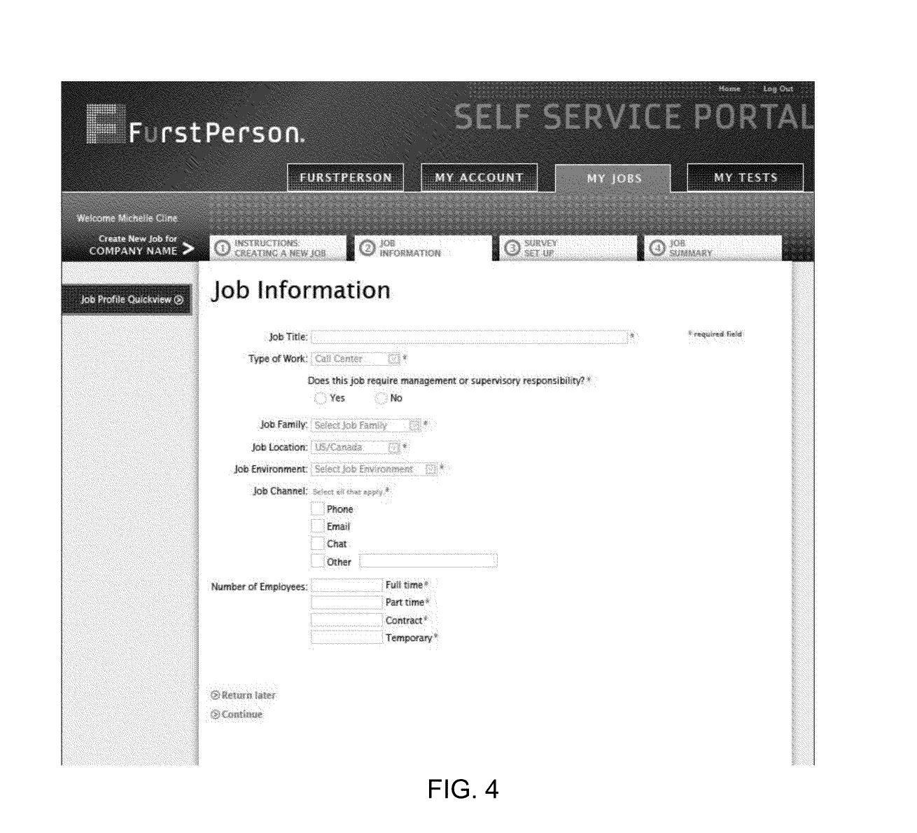

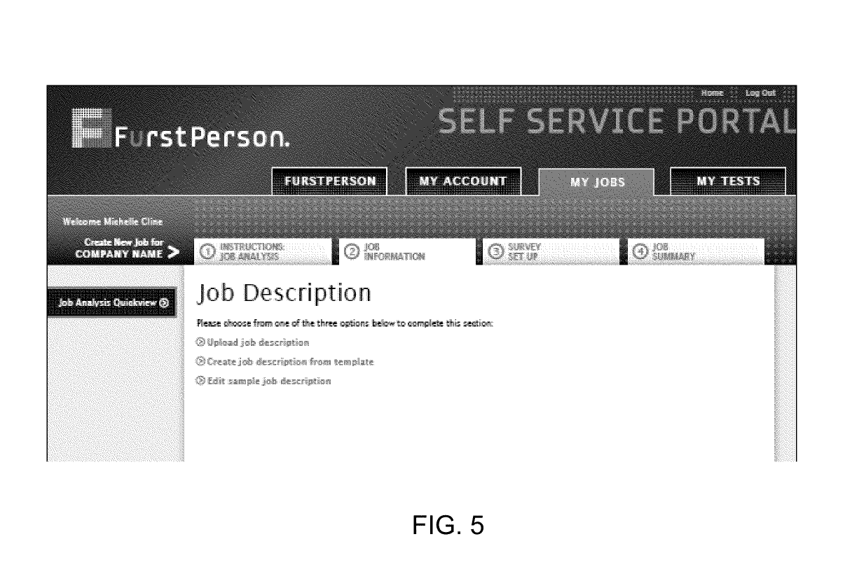

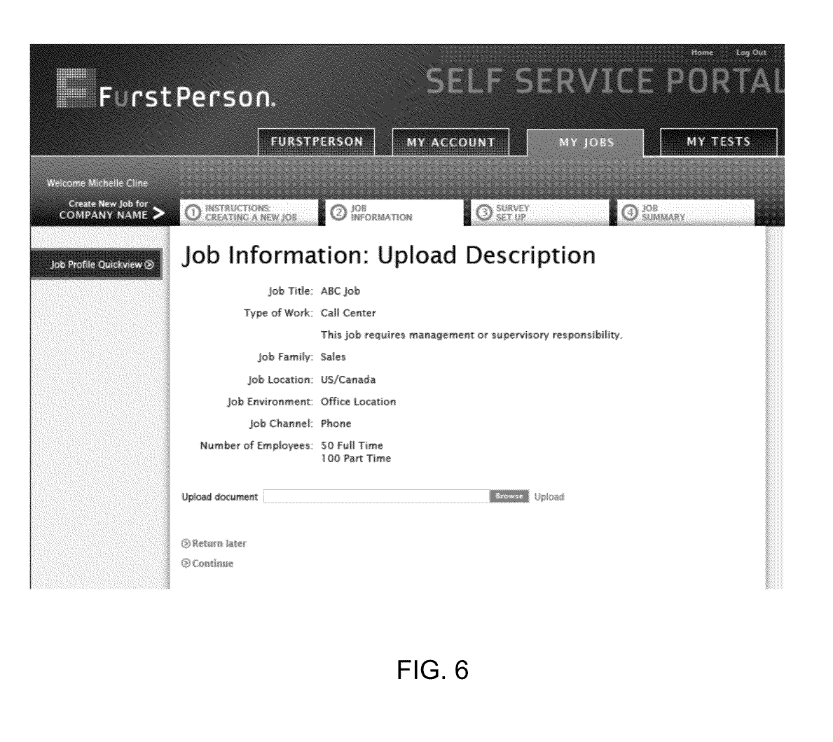

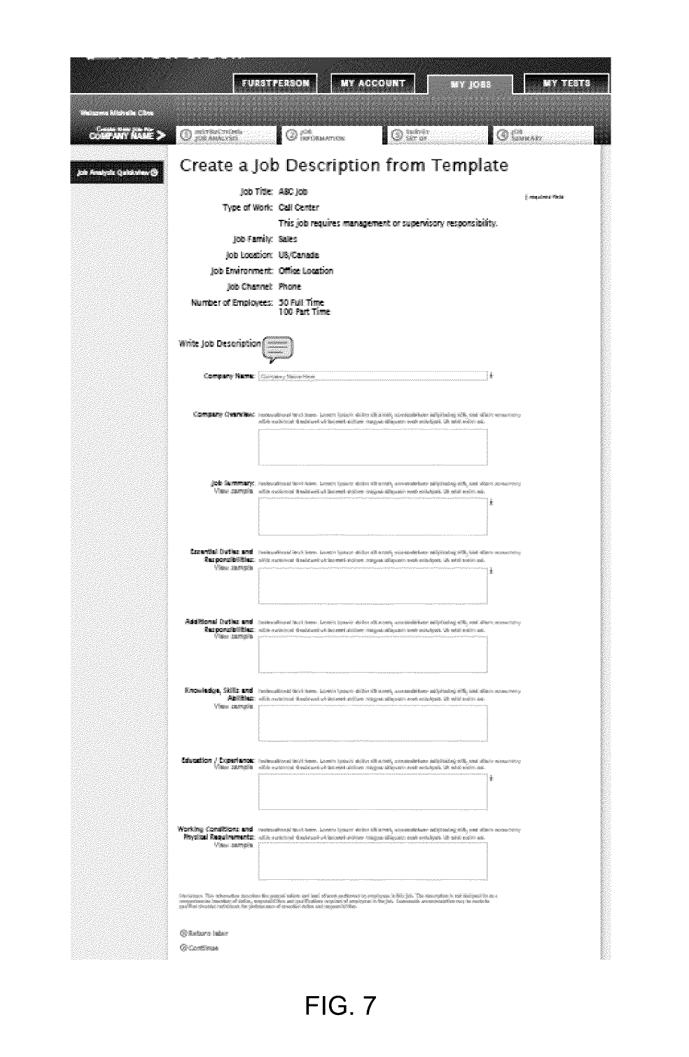

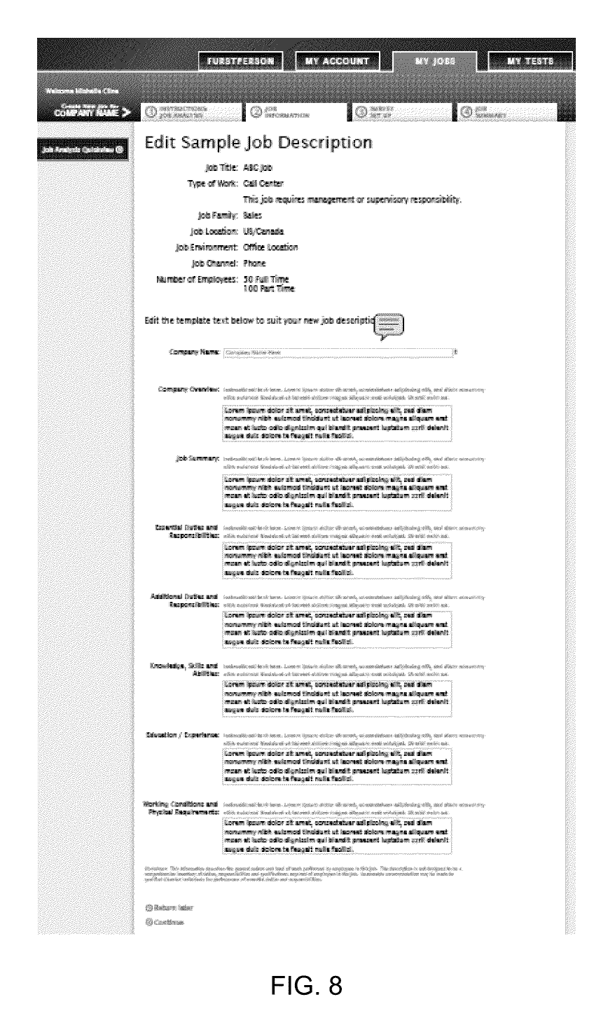

Illustrated in FIGS. 3-8 are screenshots of one implementation of a system and method for automating pre-employment assessment and creating a customized pre-employment assessment tool. More specifically, FIG. 3 illustrates one example of a user interface for creating a new job. In addition, FIG. 4 illustrates one example of a user interface for inputting job information. In addition, FIG. 5 illustrates one example of a user interface for inputting a job description and editing an existing job description. In addition, FIG. 6 illustrates one example of a user interface for uploading a job description. In addition, FIG. 7 illustrates one example of a user interface for creating a job description from a template. In addition, FIG. 8 illustrates one example of a user interface for editing sample job descriptions (i.e., template editing capabilities).

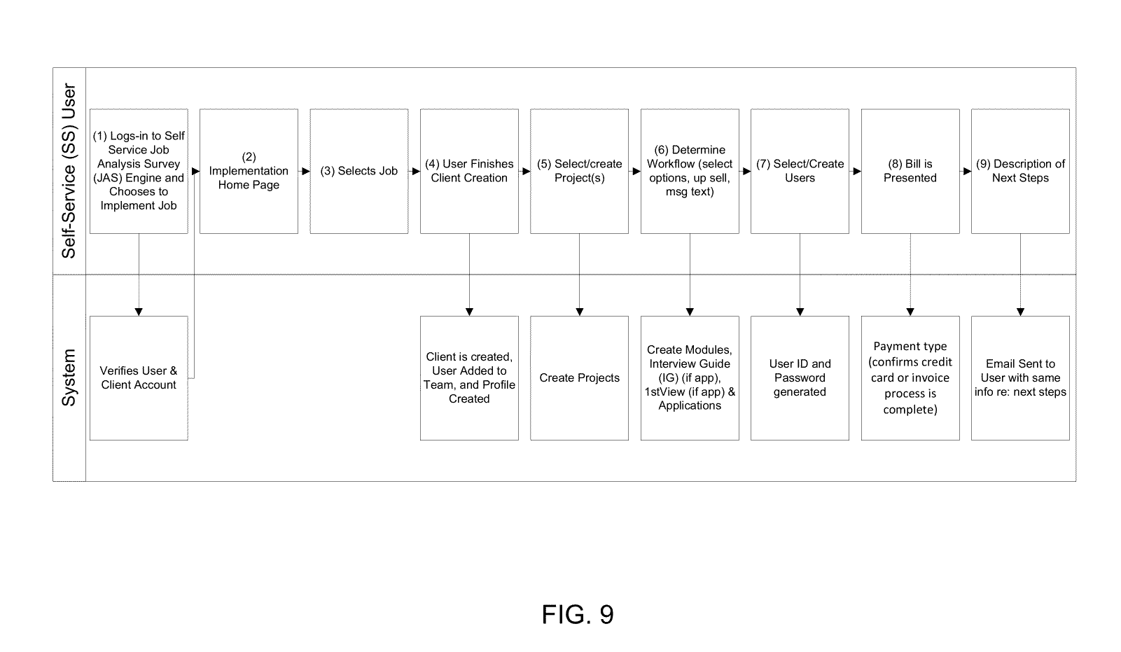

Illustrated in FIG. 9 is one example of a self-service implementation process for automating pre-employment assessment.

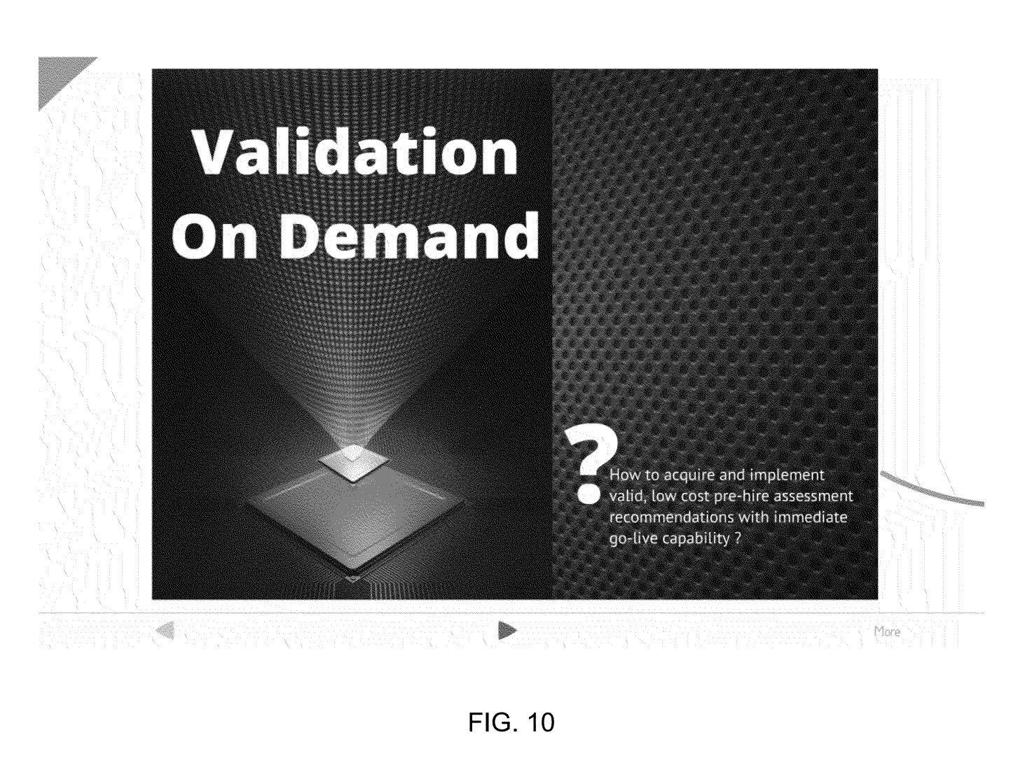

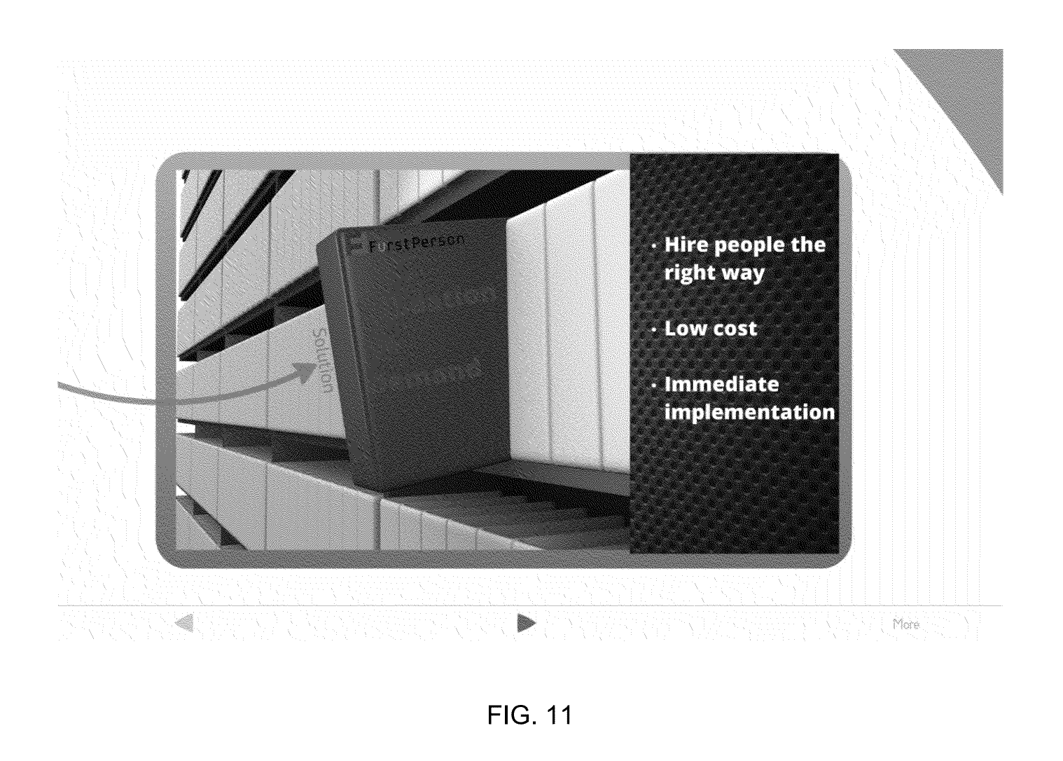

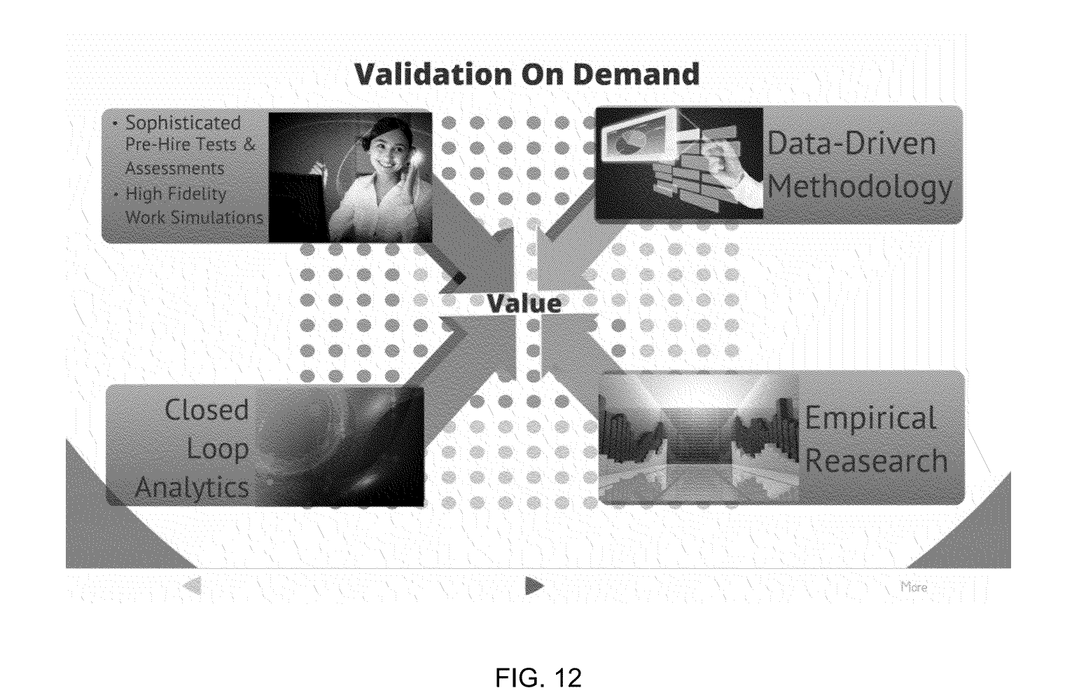

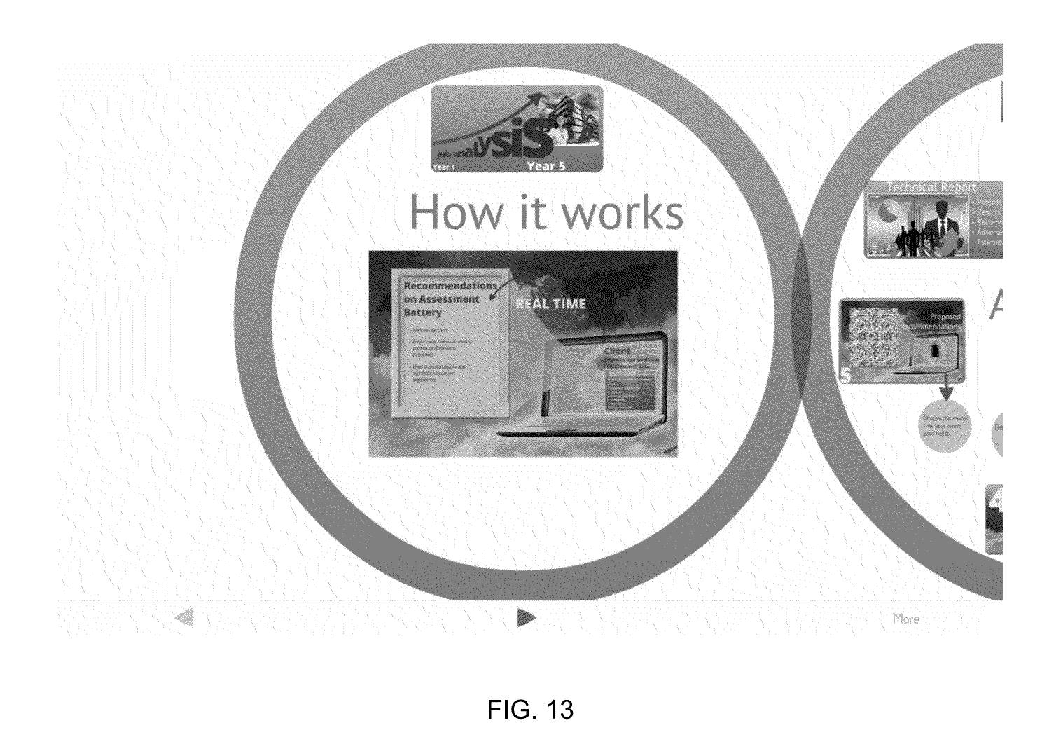

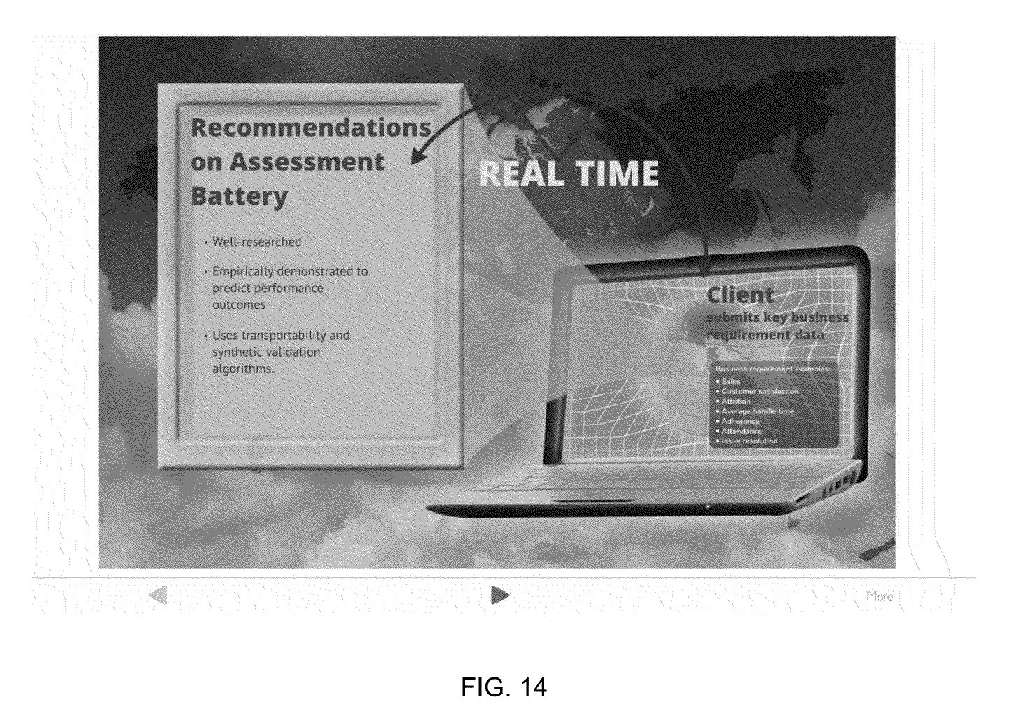

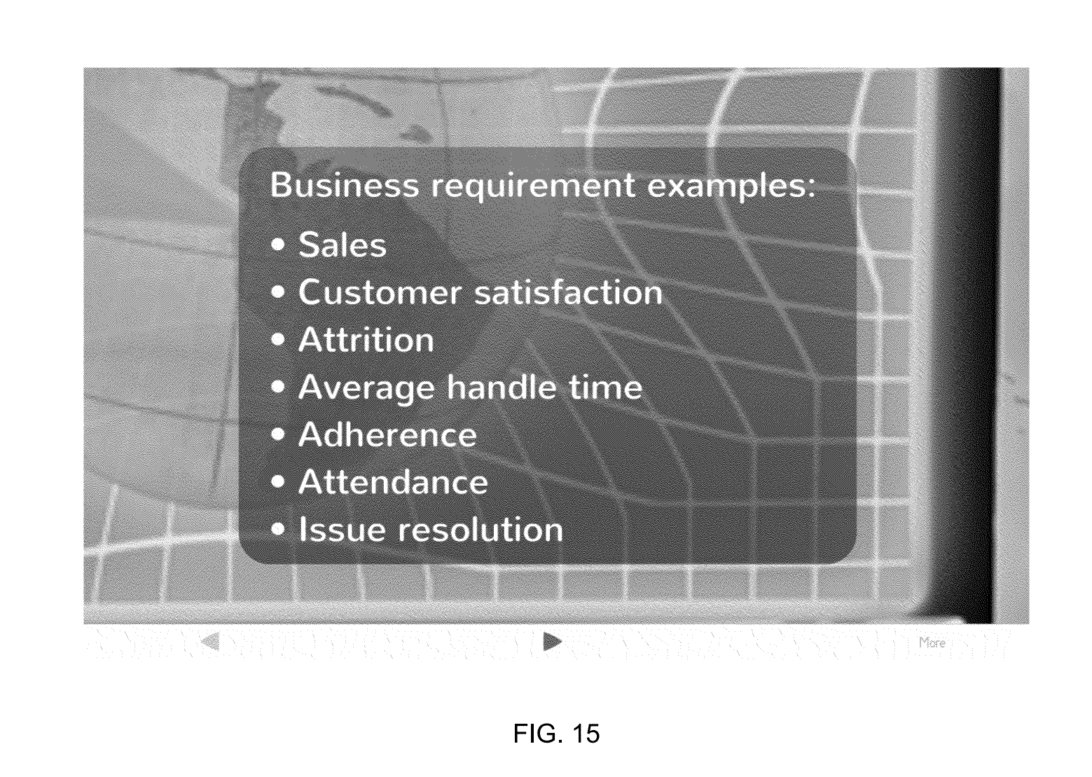

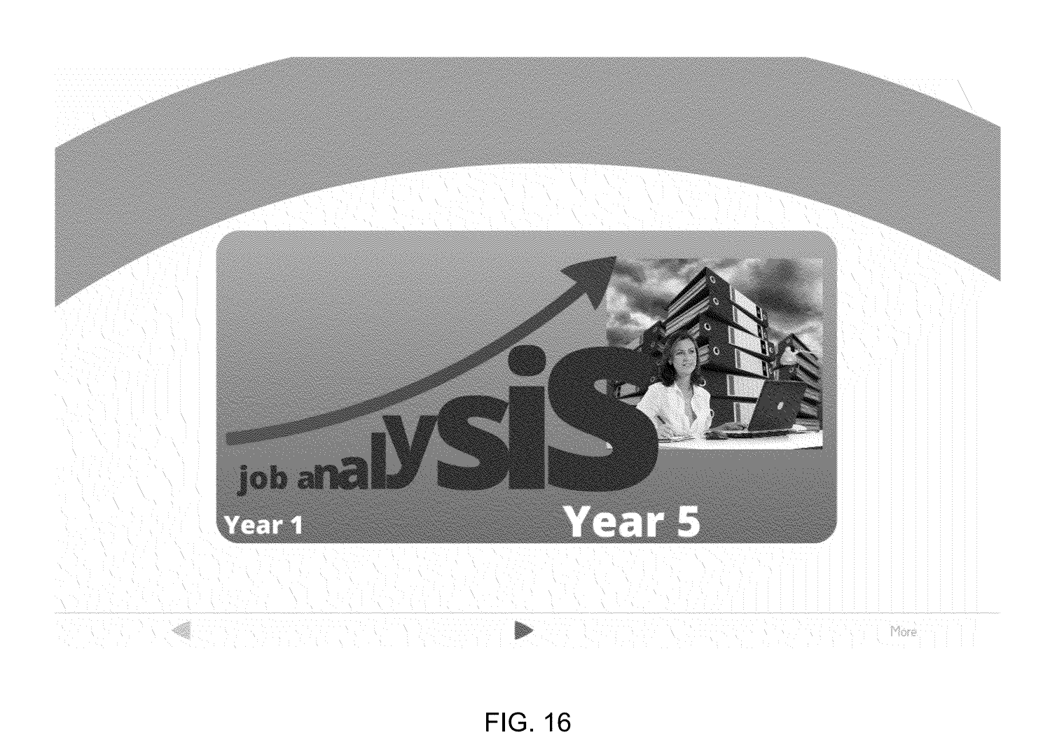

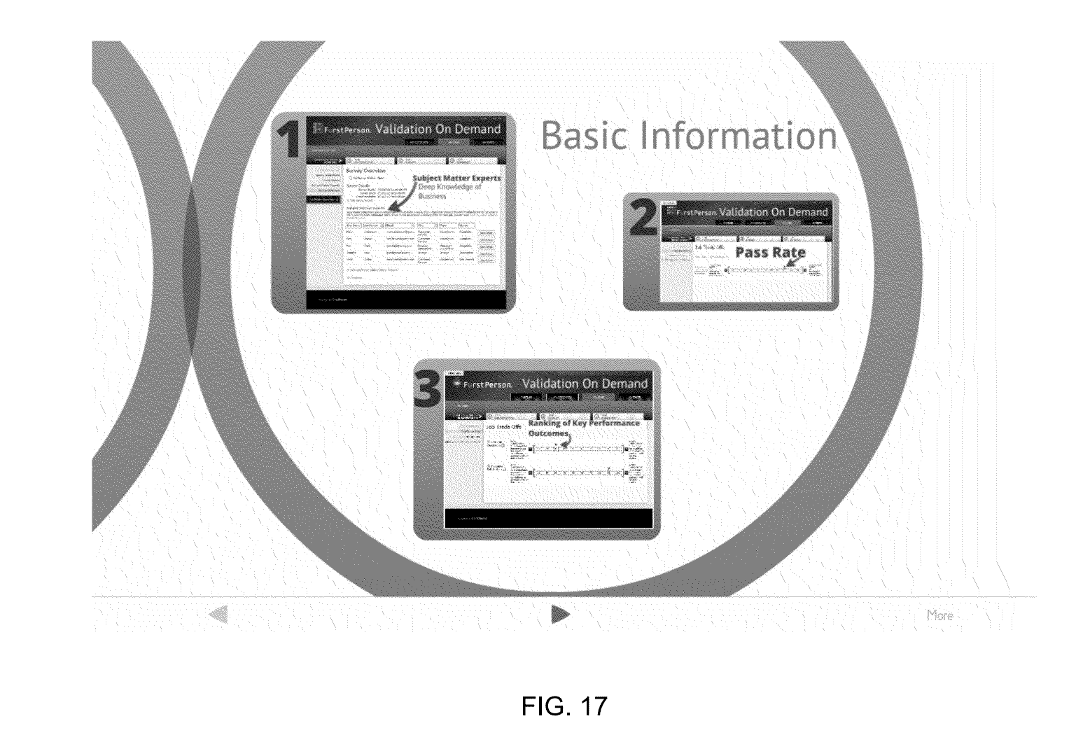

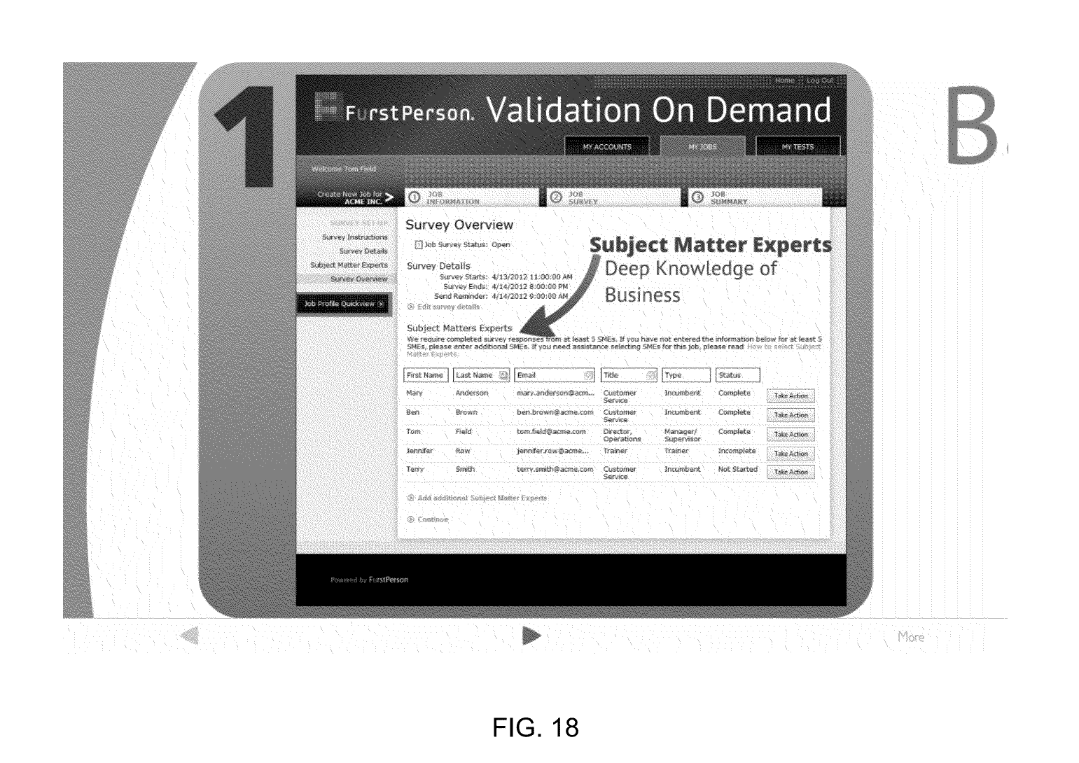

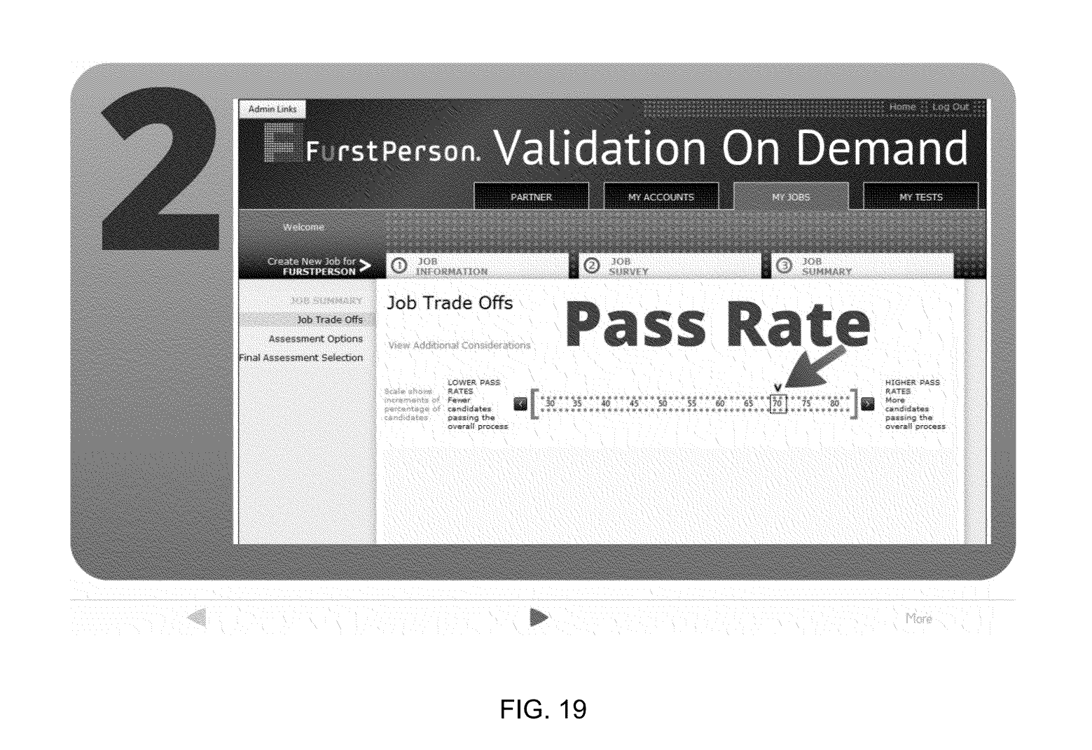

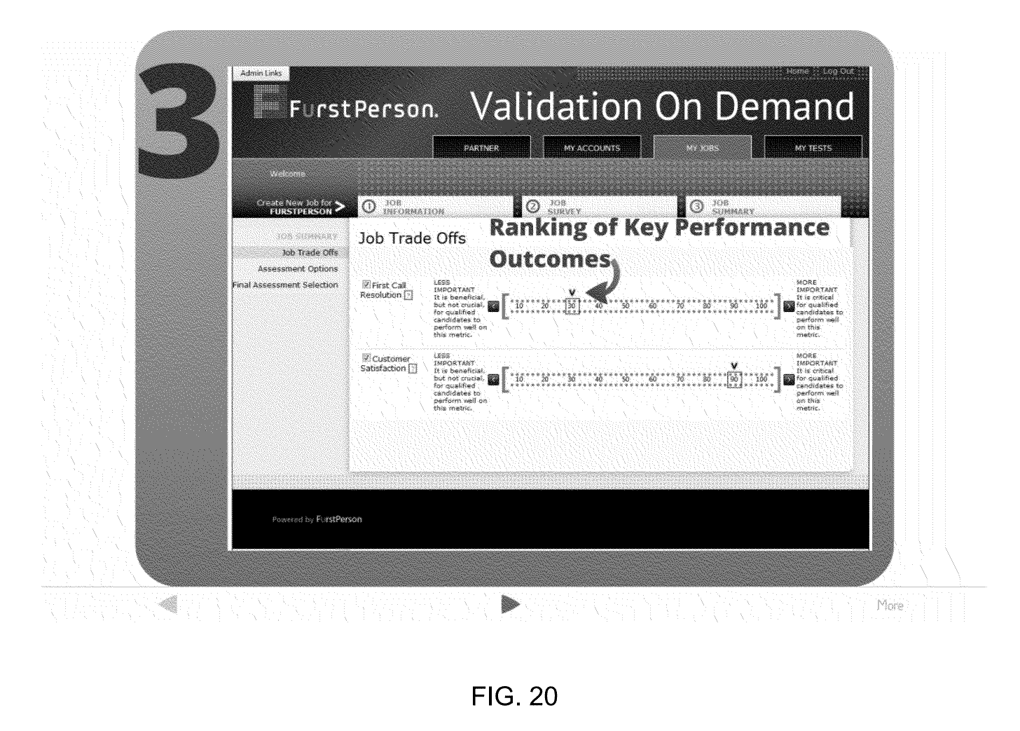

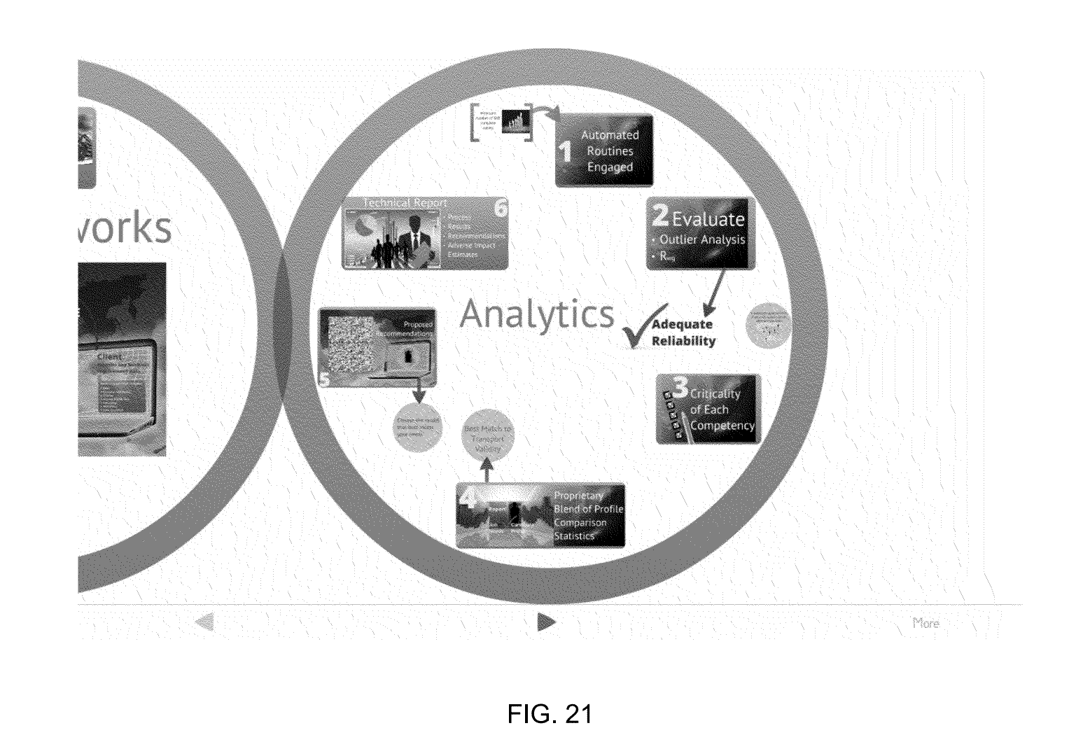

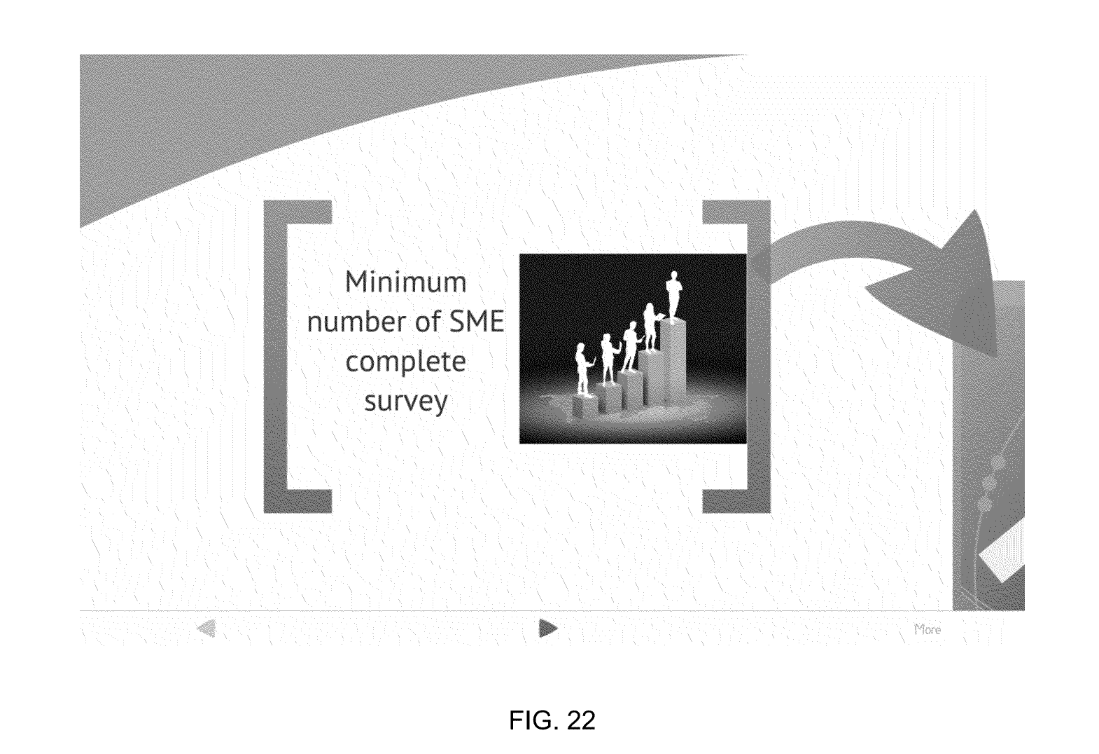

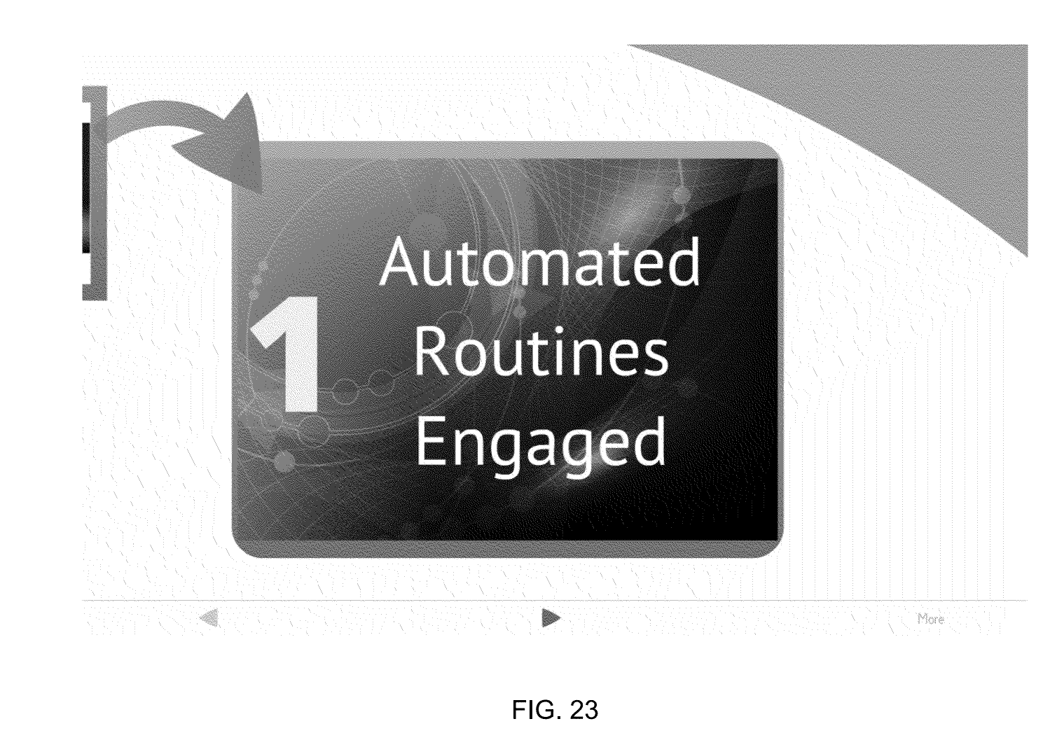

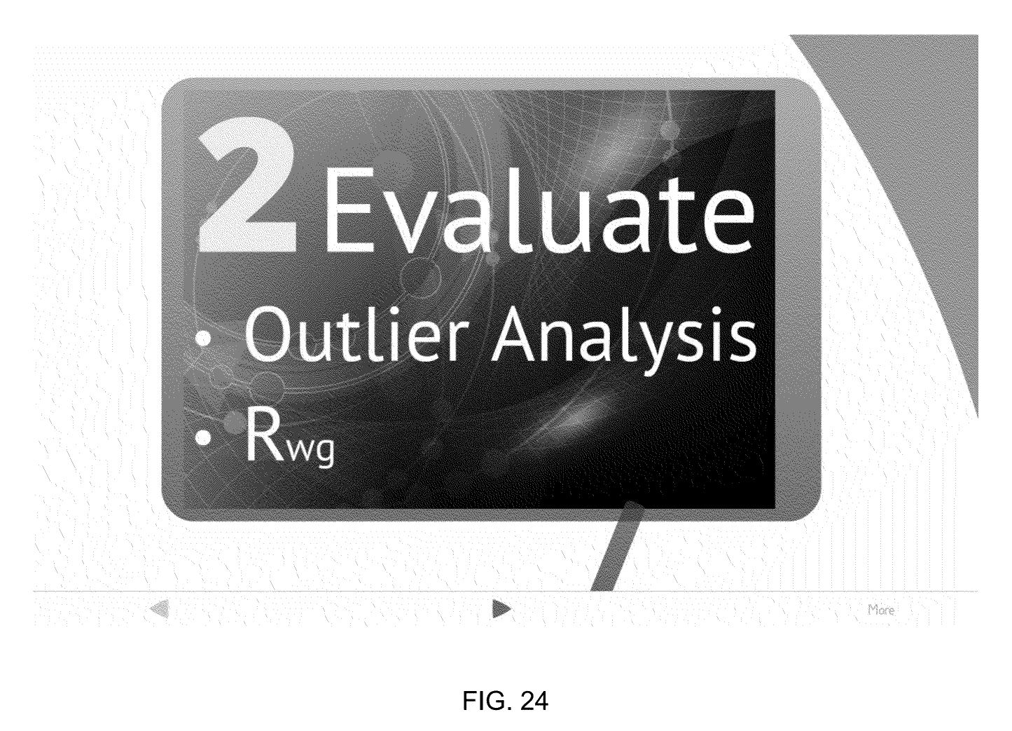

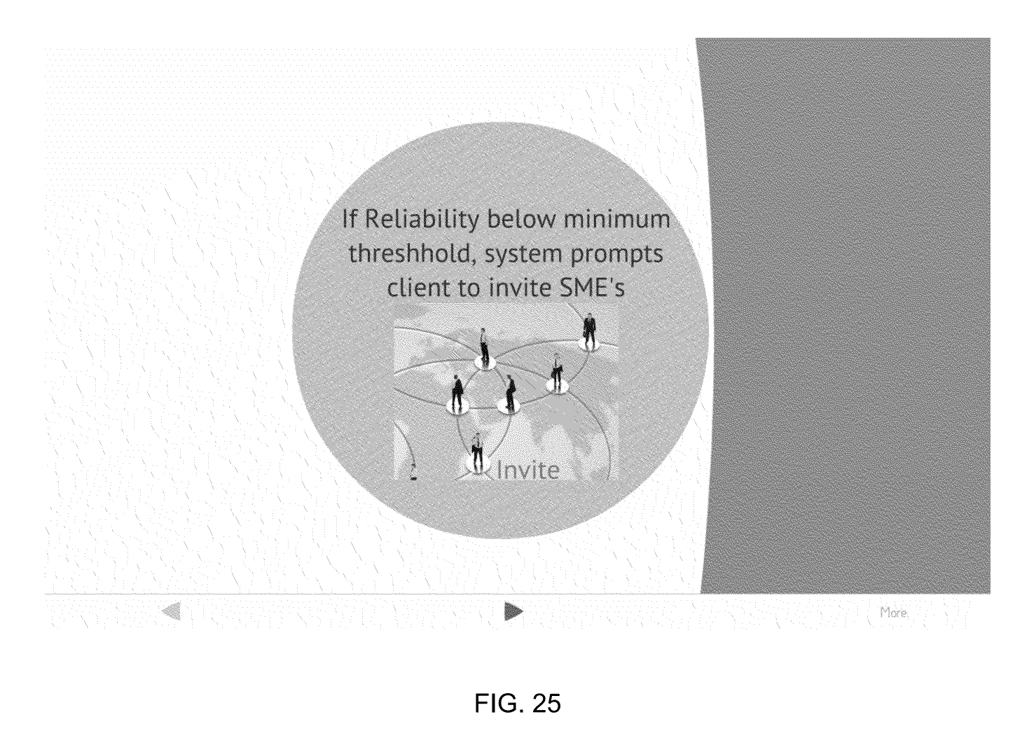

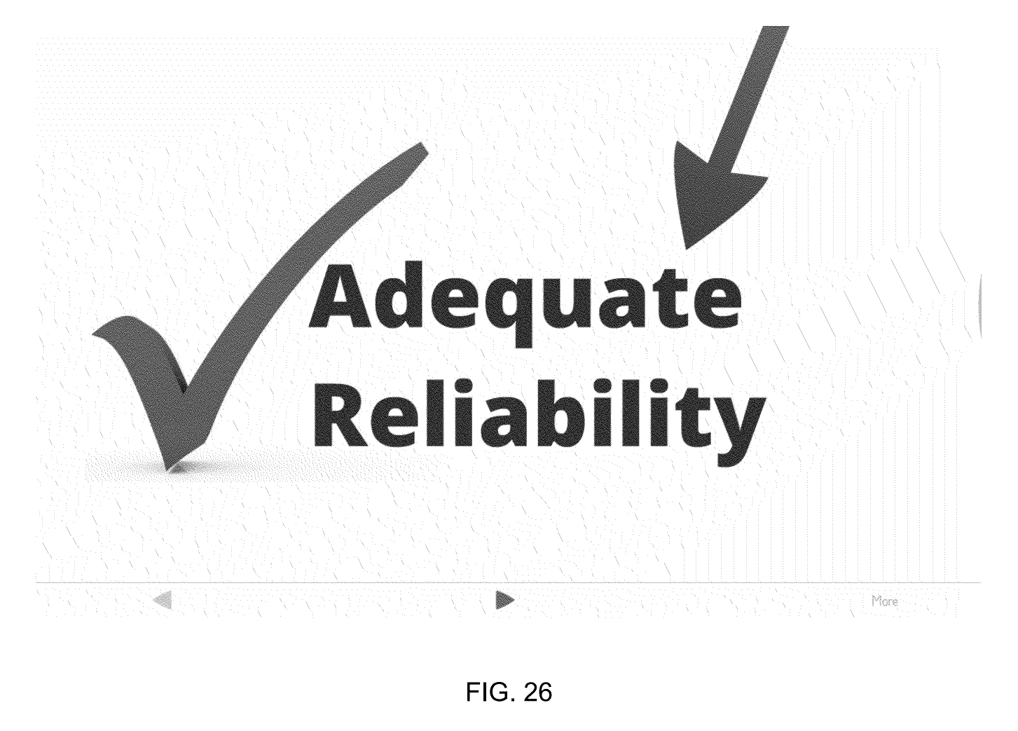

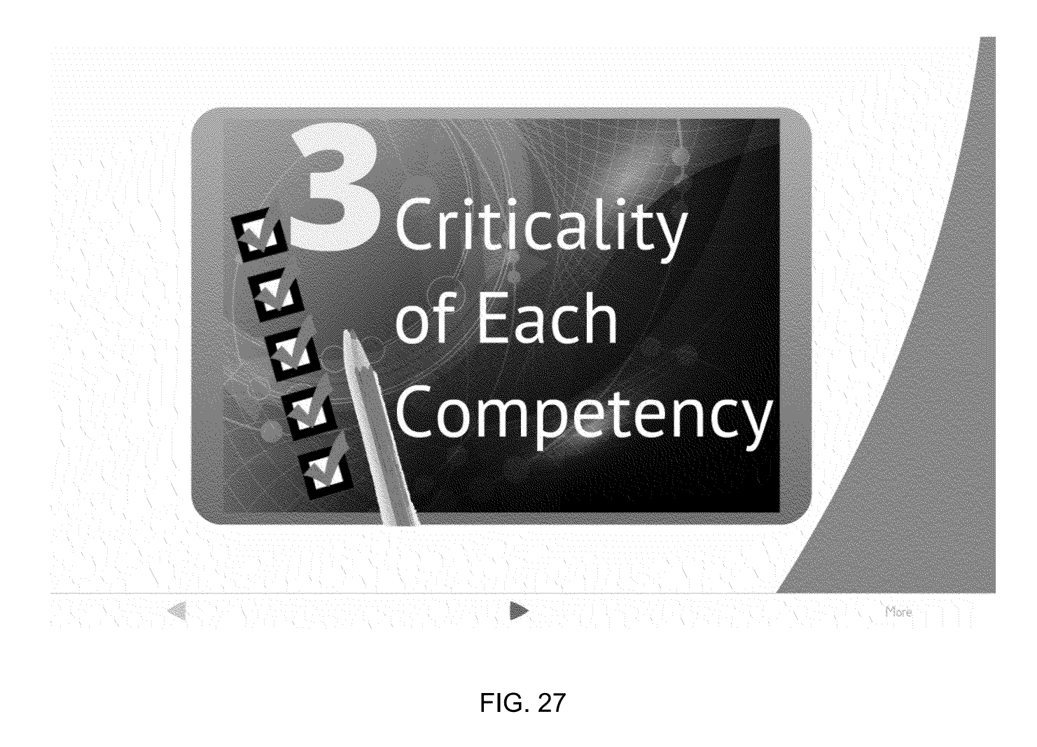

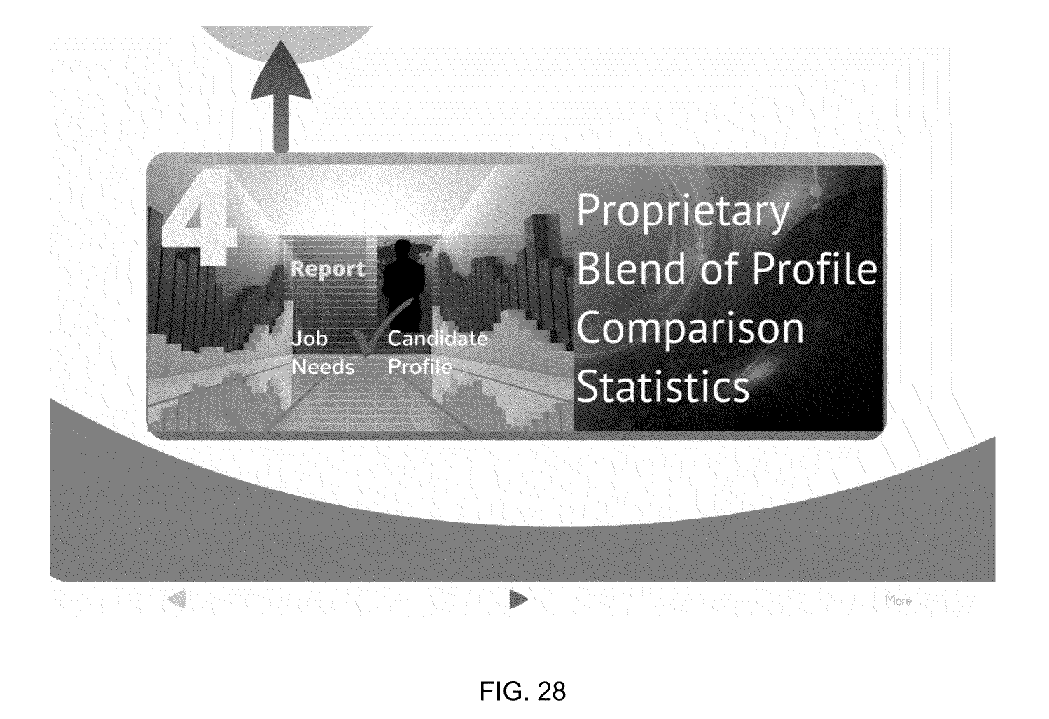

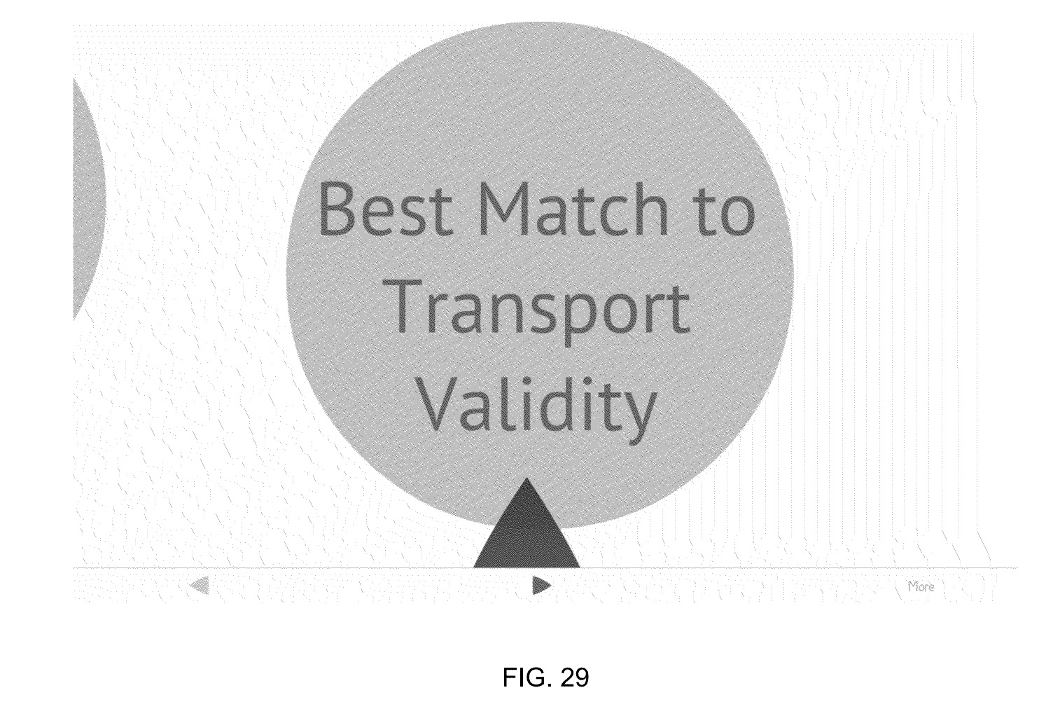

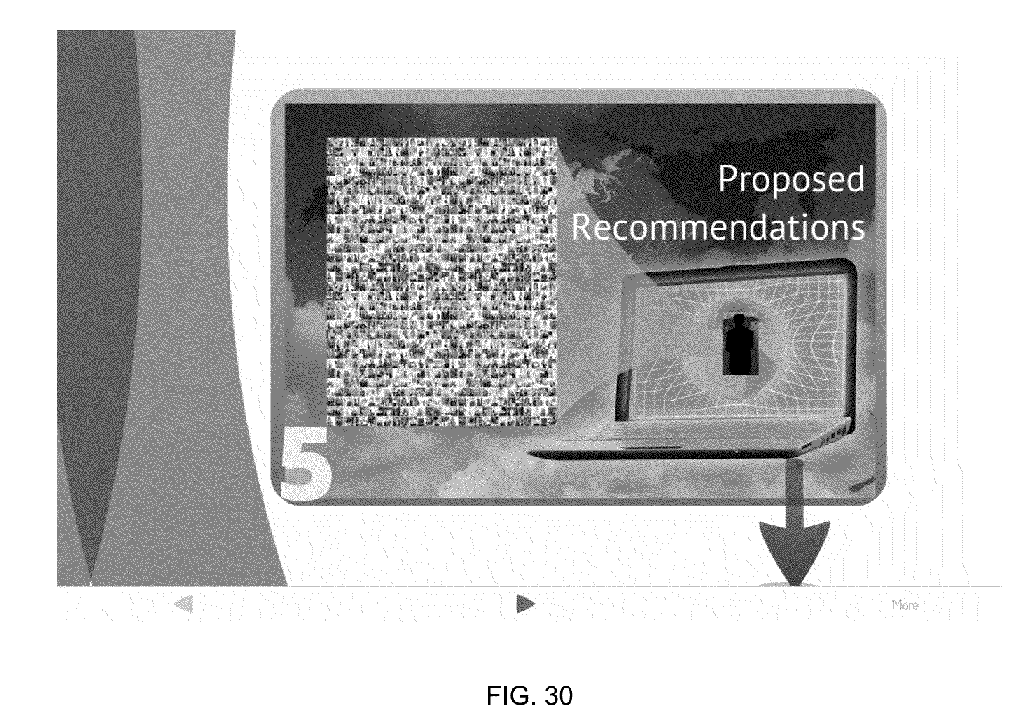

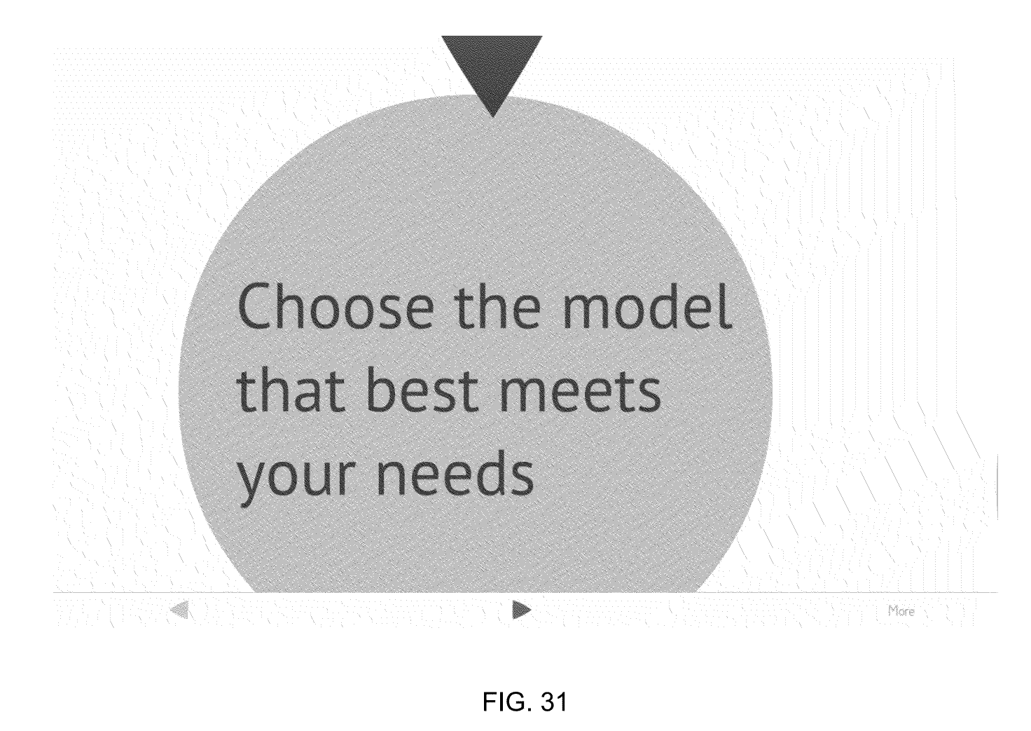

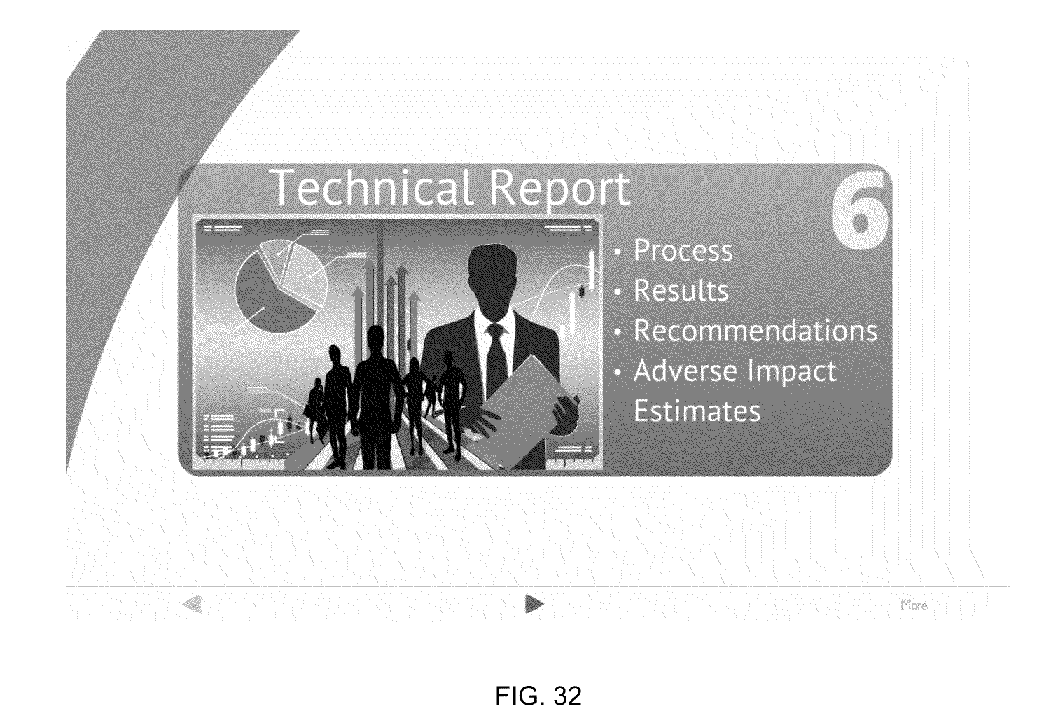

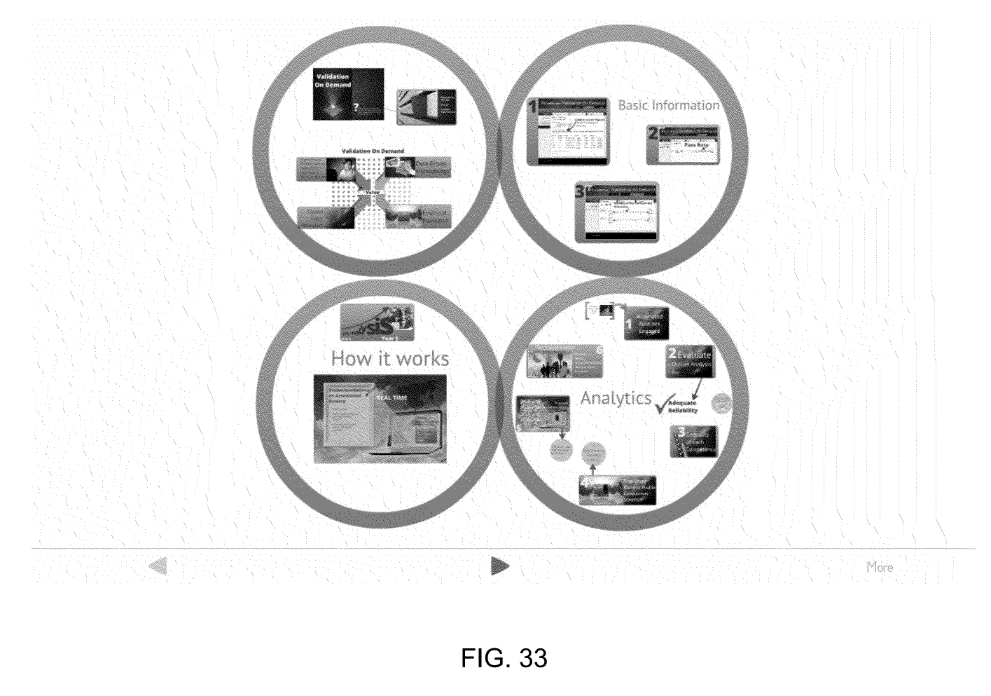

Illustrated in FIGS. 10-33 is one example of a validation on demand system and method as an example of a system and method for automating pre-employment assessment.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A system for automating pre-employment assessment, comprising:
a portal to:
implement creation of a new job, including creation of a job description for the new job; and
a processor to:
tabulate results of a job analysis survey for the new job;
compare the new job to archived jobs;
receive input of business requirements for the new job;
recommend assessment battery options for the new job based on the results of the job analysis survey, the comparison of the new job to archived jobs, and the business requirements; and
receive selection of an assessment battery option for the new job from the recommended options.

2. The system of claim 1, wherein creation of the job description for the new job includes one or more of a user-uploaded job description, entry of job competency or functional area, and edit of a sample job description provided by the system.

3. The system of claim 1, wherein the job analysis survey is to be completed by subject matter experts.

4. The system of claim 1, further comprising:
the processor to:
confirm inter-rater reliability of the job analysis survey results, and, if inter-rater reliability is not acceptable, redirect a user to gather more survey results, and, if inter-rater reliability is acceptable, close out the job analysis survey.

5. The system of claim 1, wherein the comparison of the new job to archived jobs includes computation of transportability of a job analysis survey from an archived job to the new job, including identification of primary competencies for the new job, computation of a match score to identify the archived job to transport from, and identification of potential predictors of performance outcome from the archived job.

6. The system of claim 5, wherein the comparison of the new job to archived jobs further includes use of synthetic evidence to identify potential predictors of performance outcome.

7. The system of claim 1, wherein the business requirements include one or more of a pass rate of an assessment battery, a testing length of an assessment battery, and performance metrics.

8. The system of claim 7, wherein the performance metrics include rank of one or more of issue resolution, customer satisfaction, attrition, sales, handle time, adherence, and attendance.

9. The system of claim 1, wherein the assessment battery options include assessment content for one or more of biographical data, personality, cognitive, and simulations.

10. The system of claim 1, further comprising:
the processor to:
generate a report, the report including one or more of summarization of process, summarization of recommendations, and summarization of adverse impact estimates.

11. The system of claim 10, wherein the report conforms to Equal Employment Opportunity Commission Uniform Guidelines On Employee Selection Procedures.

12. The system of claim 1, further comprising:
the processor to:
enable use of the system as a self-service employee selection system by a user.

13. The system of claim 1, further comprising:
the processor to:
implement closed-loop analytics of the system, the closed-loop analytics including capture and analysis of performance data to establish a link between job performance and hiring information.

14. The system of claim 1, wherein the performance data is captured from one or more of performance appraisals and surveys or a database holding performance metrics.

15. A method of automating pre-employment assessment, the method implemented by a computing system having a processor and memory, the method comprising:
creating a job description for a new job;
initiating a job analysis and tabulating results of a job analysis survey for the new job;
initiating a job mapping process and comparing the new job to archived jobs;
receiving input of business requirements for the new job;
recommending assessment battery options for the new job based on the results of the job analysis survey, the comparing of the new job to archived jobs, and the business requirements; and
receiving selection of an assessment battery option for the new job from the recommended options.

16. The method of claim 15, wherein creating the job description for the new job includes one or more of uploading the job description, entering of job competency or functional area, and editing of a sample job description provided by the system.

17. The method of claim 15, wherein comparing the new job to archived jobs includes one or more of:
computing transportability of a job analysis survey from an archived job to the new job, including identifying primary competencies for the new job, computing a match score to identify the archived job to transport from, and identifying potential predictors of performance outcome from the archived job, and
identifying potential predictors of performance outcome from synthetic evidence.

18. The method of claim 15, wherein the business requirements include one or more of a pass rate of an assessment battery, a testing length of an assessment battery, and performance metrics,
wherein the performance metrics include rank of one or more of issue resolution, customer satisfaction, attrition, sales, handle time, adherence, and attendance.

19. The method of claim 15, further comprising:
implementing closed-loop analytics of the system, including capturing and analyzing performance data to establish a link between job performance and hiring information.

20. A computer-implemented system for automating pre-employment assessment, comprising:
a job analysis engine to receive end-user preferences of a target job;
an automated job mapping, validation engine in communication with the job analysis engine, the automated job mapping, validation engine to receive end-user performance metrics for the target job; and
workflow logic and automation in communication with the automated job mapping, validation engine, the workflow logic and automation to provide an end-user employee-selection model,
wherein the end-user employee-selection model recommends assessment battery options for the new job based on job analysis of the target job, mapping of the target job to archived jobs, and the performance metrics for the target job.
